(19) United States
(12) Patent Application Publication
(10) Pub. No.: US 2004/0112805 A1
(43) Pub. Date: Jun. 17, 2004

(54) Extracting energy from non-potable water of a sewer process

(76) Inventor: Philippe R. Murcia, White Plains, NY (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/320,897

(22) Filed: Dec. 17, 2002

(51) Int. Cl. C02F 1/72

(52) U.S. Cl. 210/101; 210/758

(57) ABSTRACT

Extracting energy from clean, non-potable water that had been treated at a sewage station. The extraction is by driving a water turbine and electric generator with the non-potable water, oxidizing the water as it leaves the at least one water turbine and pressurizing the oxidized, cleaned, non-potable water and mixing it with a fresh supply of clean, non-potable water to feed into the at least one water turbine. The fresh supply may be open to atmosphere and at an elevation higher than that of the at least one turbine.

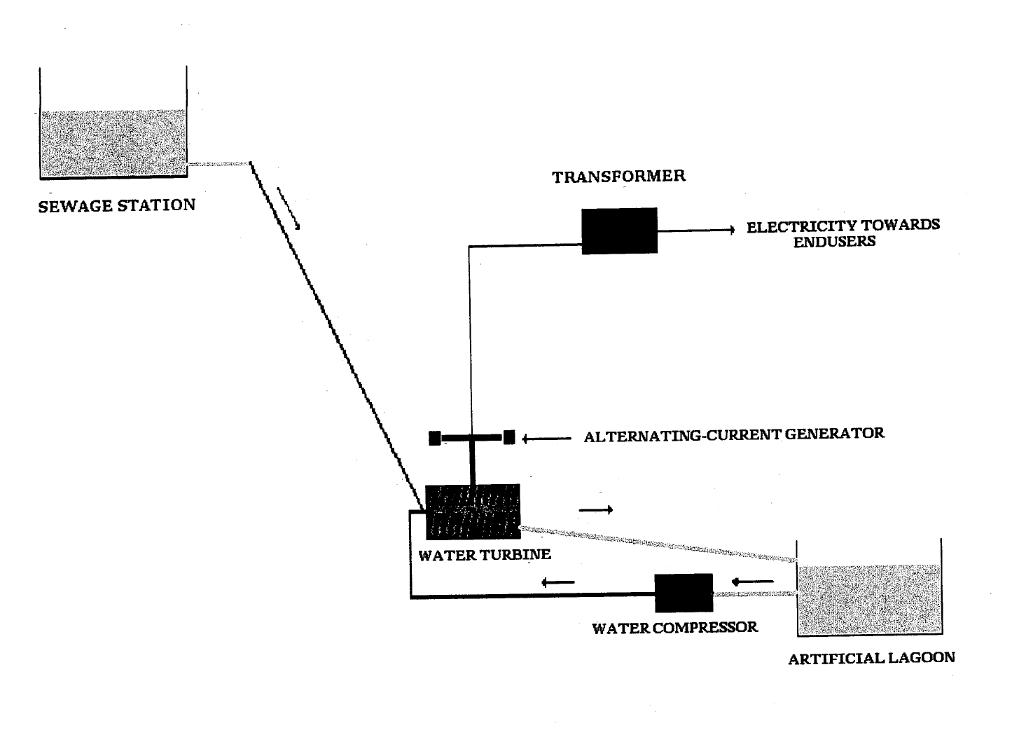

### FIELD OF THE INVENTION

The present invention relates to extracting energy such as generating electricity from clean non-potable water discharged from a sewage treatment plant.

### DISCUSSION OF RELATED ART

Municipalities have sewage treatment plants that remove sewage waste to provide clean water that still contains contaminants that render the clean water still non-potable. Typically, the non-potable water is subsequently either cleansed with reactive agents to render the clean water potable (free of contaminants that compromise human health if consumed) or discharged into the environment such as in streams, rivers, lakes, or oceans or as runoff. In some countries, the non-potable water is used for irrigation. The health risks arising from the discharge of non-potable water into the environment is well known.

Further, water is already considered a very scarce resource in many places in the world and becoming more scarce even in places where the availability of water was previously considered abundant. Even a non-potable water resource has the potential of being exploited for useful purposes in view of this scarcity of water resources and preferably should not be wasted. Indeed, municipal sewage treatment stations are known to waste as much as 95% of the water they treat.

It is known to cleanse sewage water of its sewage to provide clean, but non-potable water. The clean, non-potable water contains harmful biological contaminants, despite the cleansing of the sewage, thereby rendering the clean, non-potable water unsafe for drinking. A municipality's sewage treatment plant may generate such clean, non-potable water and discharge it into the environment. Some municipalities allow the non-potable water to be used for irrigation purposes or industrial uses. The health risks arising from the discharge of non-potable water into the environment is well known.

Further, it is known to treat non-potable water discharged from municipal sewage plants to cleanse the water of harmful biological agents and thereby render the clean water potable.

Various governmental policies encourage the production of energy that is renewable, storable and non-polluting. Non-potable water may serve as a source of non-polluting energy that is renewable, storable and non-polluting. It is therefore desirable to extract energy from the clean, non-potable water prior to discharge into the environment or elsewhere. It is further desirable to oxygenate clean, non-potable water while extracting such energy. It is further desirable to generate electricity from the extracted energy.

### SUMARY OF THE INVENTION

One aspect of the invention resides in flowing clean, non-potable water from a sewage station discharge through a water turbine, which generates electricity. The water turbine is at a lower elevation than that of the sewage station discharge.

After passing through a discharge port of the water turbine, the clean, non-potable water may be guided to flow along an open, sloped culvert or channel to reach a reservoir, which is at an elevation that is lower than that of the water turbine discharge port. While the clean, non-portable water flows along the open, sloped culvert or channel, the flowing, clean, non-potable water is exposed to the atmosphere and thus to oxygen gas in the atmosphere, which oxygenates the clean, non-potable water at least to some extent. As a result, the oxygenated, non-potable water is cleaner than it was prior to being oxygenated and thus closer to becoming potable. The excess water in the artificial lagoon may be routed to cleansing processes that transform the oxygenated, non-potable water into potable water. These processes may include suitable membranes, biological and chemical agents, or a purified charcoal bed.

The clean, non-potable water in the reservoir that has been oxidized at least to some extent is drawn into a water compressor such as by pumping action. The pressurized, clean non-potable water is then discharged from the water compressor to mix with a fresh supply of the clean, non-potable water from the sewage station discharge and the mixture enters the water turbine.

As the turbine blades of the water turbine spin or turn under force from the mixture, an alternating current generator turns it is rotors in unison with the turbine blades to generate alternating current as a result of the rotors passing stators. A transformer converts the alternating current into electricity for use by end users.

### BRIEF DESCRIPTION OF THE DRAWING

The drawing shows a schematic representation of various components of the invention relative to each other.

### DETAILED DESCRIPTION OF THE DRAWING

The drawing shows a sewage station that contains clean, non-potable water. Such water results from cleansing sewage water of its sewage contaminants. However, although the water is clean, it is non-potable and not suited for drinking since it still contains biological organisms that are harmful to humans if consumed.

Municipalities that have sewage stations typically discharge such clean, non-potable water into the environment or provide it for commercial or industrial uses, such as for washing purposes in a car wash. Some municipalities further treat the clean, non-potable water to render it potable. Such treatment usually involves a membrane process or a reactive agent that reacts with biological organisms or chemicals that have harmful properties to either eliminate or neutralize such harmful properties.

What has been overlooked by municipalities or others who run sewage treatments plants is that the clean, non-potable water may serve as a source of energy before it is discharged into the environment, supplied to commercial or industrial end users, or further treated to render it more potable. That is, the clean, non-potable water may be discharged from a sewage station discharge port to drive a water turbine, which in turn drives an alternating current generator to generate alternating current that is transformed by a transformer into electricity for use by end users.

Further, the water discharged from the water turbine may flow along an open culvert or channel to collect in an artificial lagoon or other type of reservoir. A water compressor may be used to draw out water from the artificial lagoon or other type of reservoir to mix with a fresh supply of the clean, non-potable water from the sewage station to enter the water turbine to spin or turn turbine blades. The alternating current generator may have rotors that turn in unison with the turbine blades so that as they pass over stators, the alternating current is generated.

The sewage station may provide clean, non-potable water to a plurality or series of water turbines, each preferably equipped with its own alternating current generator. All the alternating current generators may share the same transformer if in accordance with electrical standards of the municipality or each may send their alternating current to a corresponding transformer. Further, the water discharged from each of the water turbines may flow along a common, open, sloped culvert or channel to reach a common, artificial lagoon or, if desired, be routed instead through corresponding sloped culverts or channels to the same or respective artificial lagoons.

A common compressor and/or pump may suck out water from the artificial lagoon to feed each of the water turbines with pressurized water. Appropriate controls may be provided to regulate the pressure of the pressurized water. For instance, the pressure of the pressurized water may be regulated to match, make up or otherwise compensate for a reduction in the pressure head, which reduction arises if there is a drop in elevation of the clean, non-potable water supply level at the sewage station. This compensation helps maintain a constant water supply pressure to the water turbine. Further, the sewage station may have an open reservoir containing the clean, non-potable water and the artificial lagoon may be open to the atmosphere as well.

The artificial lagoon can only hold so much of the oxygenated, non-portable water to meet the demand of the water turbine for pressurized water. Beyond that amount, the oxygenated, non-potable water in the artificial lagoon is in excess. Such excess may be discharged to a further artificial lagoon. If desired, appropriate measures may be taken to render this excess potable. For instance, cleansing processes may be introduced that transform the oxygenated, non-potable water into potable water. These processes are conventional and may include suitable membranes, biological and chemical agents, or a purified charcoal bed. While such processes are conventional, the inventor is unaware of any such processes being applied upstream of such cleansing processes and downstream of sewage treatment of non-potable water.

The artificial lagoon, therefore, may have two discharge ports at different elevations. The lower one directs the flow to the water turbine and the higher one is for excess to direct the excess further downstream to a further artificial lagoon at a lower elevation where the water may be cleansed further with appropriate treatment process to be transformed into potable water. The discharges from the artificial lagoon to the water turbine and to the further artificial lagoon may be along culverts or channels that are open to the atmosphere and thereby exposed to oxygen gas, which may further oxygenate the water. If needed, a pump may be used to pump the water from the artificial lagoon to the water compressor and/or to the water turbine.

If desired, the culvert or channel may be replaced by piping, which preferably would still allow for oxygenation. Various conventional techniques for treating non-potable water to cleanse it further, such as biological, chemical, membrane or purified charcoal bed as mentioned previously, may be arranged between the water turbine and the artificial lagoon and/or between the water compressor and the artificial lagoon. Indeed, other techniques for oxygenating the non-portable may be employed other than mere exposure to the atmosphere, such as bubbling an oxygen containing gas through the non-potable water downstream of the water turbine and/or at a location between the artificial lagoon and the water compressor.

What is claimed is:

1. An energy extractor of non-potable water, comprising a non-potable water supply, at least one water turbine and alternating current generator, a reservoir arranged to receive discharge from the water turbine, and at least one water compressor arranged to pressurize water from the reservoir and discharge same to mix with a fresh supply of non-potable water from the non-potable water supply at a location upstream of the at least one water turbine.

2. An energy extractor as in claim 1, wherein the non-potable water supply is open to atmosphere and at an elevation that is higher than that of the at least one water turbine.

3. An energy extractor as in claim 1, wherein the reservoir is open to atmosphere and is at an elevation lower than that of the at least one water turbine.

4. An energy extractor as in claim 1, wherein the water compressor pressurizes the water at a pressure that is substantially the same as a pressure of the fresh supply.

5. An energy extractor as in claim 4, wherein the reservoir is open to atmosphere and is at an elevation lower than that of the at least one water turbine.

6. An energy extractor as in claim 1, further comprising an open culvert or channel arranged between the at least one water turbine and the reservoir.

7. An energy extractor as in claim 1, further comprising an open culvert or channel arranged between the at least one water compressor and the reservoir.

8. An energy extractor as in claim 1, further comprising oxygenating the non-potable water at a location that is downstream of the water turbine and upstream of the reservoir.

9. An energy extractor as in claim 1, further comprising oxygenating the non-potable water at a location between the reservoir and the water compressor.

10. A method of extracting energy from non-potable water, comprising discharging a mixture of non-potable water from a water turbine, filling a reservoir with the mixture, pressurizing at least a portion of the mixture from the reservoir and mixing same with the non-potable water from a non-potable water supply and supplying same to the water turbine.

11. A method as in claim 10, further comprising turning blades of the turbine with flow of the non-potable water through the water turbine and generating alternating current as the blades turn.

12. A method as in claim 10, further comprising oxygenating the non-potable water downstream of the water turbine.

13. A method as in claim 10, further comprising oxygenating the non-potable water upstream of the water compressor.
